(19) United States
(12) Patent Application Publication
(10) Pub. No.: US 2006/0127640 A1
(43) Pub. Date: Jun. 15, 2006

(54) Glass substrate with fine hole and method for producing the same

(76) Inventors: Fumitoshi Kobayashi, Osaka (JP); Katsuhide Shimmo, Osaka (JP); Naoko Hikichi, Osaka (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/350,830

(22) Filed: Feb. 10, 2006

Related U.S. Application Data
(62) Division of application No. 10/358,209, filed on Feb. 5, 2003.

(30) Foreign Application Priority Data
Feb. 5, 2002 (JP) P2002-027816

(51) Int. Cl. B32B 3/10

(52) U.S. Cl. 428/131

(57) ABSTRACT

As a feature of a glass substrate having at least one fine hole according to the invention, a side wall surface of the fine hole is connected to each surface of the glass substrate by a curved surface as a boundary portion between the two. As another feature of the glass substrate, a layer denatured by machining is removed from the inner wall surface of the fine hole and the boundary portion between the wall surface and each surface of the glass substrate. The fine hole is produced by: forming a fine hole in a glass substrate by machining or laser machining; and then applying liquid-phase chemical etching to surfaces of the glass substrate and the fine hole. On this occasion, it is desirable that the etching liquid used for the liquid-phase chemical etching is either of an aqueous solution of hydrofluoric acid and an aqueous mixture solution of hydrofluoric acid and ammonium fluoride.

### BACKGROUND OF THE INVENTION

The present invention relates to a glass substrate having at least one fine hole which serves as a guide hole for mounting an optical fiber used in the field of optical communication or as an ink ejection hole for a printer used in the field of office automation equipment.

A board made of a plate-like resin material such as a polyimide-based resin or a fluorocarbon-based resin and provided with fine through-holes is used widely as a multilayer wiring board for electronic appliance, a head of an ink-jet printer, a retention member of an optical fiber array, etc. Each of the through-holes serves as an electric contact hole in the multilayer wiring board, as an ink ejection hole in the head of the ink-jet printer or as an optical fiber guide hole in the retention member of the optical fiber array.

Each of the through-holes has a diameter in a range of from the order of tens of pm to about 200 μm. A laser beam machine using a CO laser, a YAG laser, or an excimer laser of KrF or the like is generally used for forming these holes.

On the other hand, because glass has a feature to be superior in chemical stability and heat resistance to resin, a glass substrate having fine holes formed therein can be adapted for more use purposes. If the glass substrate is subjected to laser machining, there is however a problem that the glass substrate cracks easily.

As measures to solve this problem, a technique in which a glass substrate is heated at a temperature of 300° C. to 700° C. before laser machining so that the glass substrate can endure heat shock at the time of laser machining has been disclosed in JP-A-54-28590.

Further, an example in which silver in an atomic, colloidal or ionic state is contained in a glass substrate to improve applicability of laser machining to the glass substrate has been described in JP-A-10-338539.

Although it is possible to form fine holes in a glass substrate by laser machining, it is difficult to control the diameter of each fine hole with accuracy of not larger than 1 μm.

For example, the accuracy of the hole diameter of a guide hole for mounting an optical fiber used in the field of optical communication is required so that a clearance for the diameter of the optical fiber is controlled in the order of 1 pm or smaller to ensure the positional accuracy of the optical fiber. Moreover, according to Japanese Industrial Standards (JIS) , even variation of larger than 1 μm in the diameter of the optical fiber used is allowed because the accuracy of the diameter of the optical fiber is defined as ±1 μm. It is therefore necessary that the accuracy of the hole diameter of the guide hole is kept not larger than 1 μm relative to the variation in the diameter of the optical fiber. In laser machining, it is very difficult to adjust the hole diameter.

Moreover, the hole formed by laser machining is tapered. Because the small-diameter side having large influence on the final alignment of the optical fiber is a rear surface side opposite to a front surface irradiated with laser beams, it is more difficult to control the hole diameter.

Moreover, even in the case where the crack arresting means is used at the time of laser machining, the boundary portion between the hole side surface on the small diameter side and the corresponding substrate surface is apt to be cracked or chipped because it is difficult to eliminate the influence of heat shock thoroughly. Hence, when the optical fiber is inserted into the hole, there is fear that the small-diameter side of the glass substrate may be chipped and broken pieces may be deposited on a tip of the optical fiber to disturb assembling.

In addition, the inner wall surface of the hole formed by laser machining may be denatured or cracked finely by the influence of heat. When silver-containing glass is used, there is possibility that silver colloid may precipitate. Hence, there is a further problem that the function of a product may be spoiled because glass dust or silver colloid is deposited on a tip of the optical fiber when the optical fiber is inserted into the hole.

### SUMMARY OF THE INVENTION

The invention is developed to solve the problems and an object of the invention is to provide a method for forming a through-hole in a glass substrate, by which method the hole diameter of the through-hole is controlled with high accuracy and the inner wall surface of the through-hole has no layer denatured by machining.

As a feature of the glass substrate having at least one fine hole according to the invention, a side wall surface of the fine hole is connected to each surface of the glass substrate by a curved surface as a boundary portion between the two. As another feature of the glass substrate, a layer denatured by machining is removed from the inner wall surface of the fine hole and the boundary portion between the wall surface of the fine hole and each surface of the glass substrate. It is desirable that the fine hole is tapered particularly in a direction of thickness of the glass substrate.

Because even the smallest-diameter portion of the fine hole is not chipped so that the surface of the smallest-diameter portion is formed as a smoothly curved surface, the hole diameter, for example, required when the hole is used for holding an optical fiber inserted into the hole can be easily controlled with high accuracy.

The fine hole according to the invention is produced by: forming a fine hole in a glass substrate by machining or laser machining; and then applying liquid-phase chemical etching to surfaces of the glass substrate and the fine hole. On this occasion, desirably, an etching liquid used in the liquid-phase chemical etching is either of an aqueous solution of hydrofluoric acid and an aqueous mixture solution of hydrofluoric acid and ammonium fluoride.

Laser machining is means adapted for forming a fine hole in glass. When laser machining is combined with chemical etching in liquid phase, a fine through-hole having the aforementioned sectional shape having a hole diameter controlled with high accuracy can be formed in a glass substrate by machining.

The present disclosure relates to the subject matter contained in Japanese patent application No. P2002-027816 (filed on Feb. 5, 2002), which is expressly incorporated herein by reference in its entirety.

### BRIEF DESCRIPTION OF THE DRAWINGS

FIG. 1 is a typical view showing the shape of a fine hole formed in a glass substrate by laser machining.

FIG. 2 is a typical view showing the external appearance of the fine hole in a rear surface of the glass substrate.

FIG. 3 is a graph showing the relation between etching time and change of hole diameter in an embodiment of the invention.

FIG. 4 is a typical view showing the sectional shape of a fine hole in the embodiment of the invention.

FIG. 5 is a typical view showing an applied example in which the invention is applied to an optical fiber retention member.

### DESCRIPTION OF THE PREFERRED EMBODIMENT

A feature of the invention is that a glass substrate having fine holes formed by machining or laser machining in advance is further subjected to etching to adjust the hole diameter of each fine hole and improve the quality of the inner wall surface of each fine hole.

Production of a retention member for mounting an optical fiber array will be described below. A target value of the hole diameter is set at 125 μm which is equal to the outer diameter of a single mode optical fiber used generally.

First, to form holes by laser machining, a 0.3 mm-thick glass substrate was modified by ion exchange. The method of ion exchange was basically the same as described in JP-A-10-338539. The glass substrate was made of silicate glass containing Sio₂, as a main component and further containing Al₂O₃, B₂O₃, Na₂O, F, etc. The glass substrate was immersed in a molten salt mixture containing 50% by mole of silver nitrate, and 50% by mole of sodium nitrate. The temperature of the molten salt mixture was 300° C. The immersion time was 72 hours. By this processing, Na ions in surfaces of the glass substrate were eluted while Ag ions in the molten salt mixture were diffused into the central portion of the glass substrate.

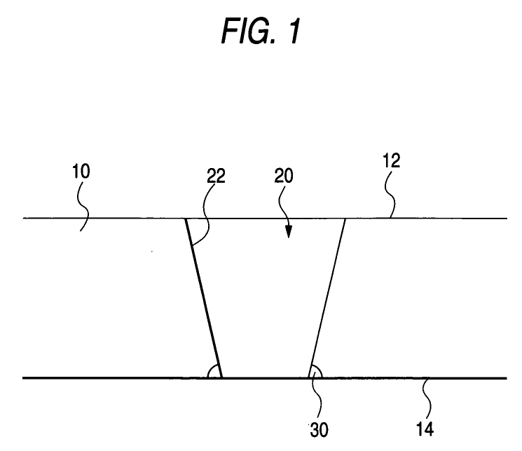

The glass substrate 10 was irradiated with light of the third harmonic wave (wavelength: 355 nm) of a YAG laser to form a through-hole by machining. On this occasion, the glass substrate 10 was irradiated with a laser beam having a beam spot diameter of 130 μm and beam power of 39 J/cm². As a result, there was obtained a fine hole 20 piercing the glass substrate 10 so as to be shaped like a taper having a diameter of 130 μm at a beam incidence side surface 12 and a diameter of 115 μm at a beam emergence (rear) side surface 14 as shown in FIG. 1. As an example, to produce a retention member for retaining an array of 4×4 optical fibers, laser beam irradiation was repeated while a stage on which the glass substrate 10 was mounted was moved. Thus, an array of 4×4 holes was formed.

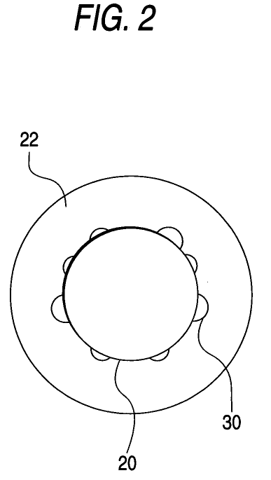

When one of the holes was observed from the beam emergence side, a large number of chips 30 were found in the boundary between the inner wall surface of the fine hole 20 and the rear surface of the glass substrate as shown in FIG. 2. It was also observed that the hole wall surface 22 was colored because it was denatured by laser machining.

Therefore, the whole of the glass substrate having the fine holes formed was etched in liquid phase according to the invention. An aqueous mixture solution of hydrofluoric acid and ammonium fluoride was used as an etching liquid. As an example, an aqueous solution of 2.5% by weight of hydrofluoric acid and an aqueous solution of 30% by weight of ammonium fluoride were mixed at the weight ratio of 1:1, so that the resulting mixture solution was used as an etching liquid.

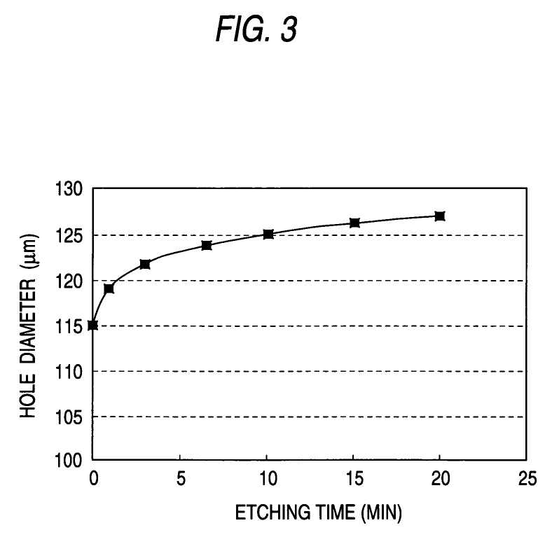

The change of the hole diameter versus the etching time in use of the etching liquid at a liquid temperature of 40° C. was as shown in FIG. 3. The hole diameter was measured at the smallest-diameter portion of the tapered hole, i.e., at the beam emergence side of the glass substrate. The initial value of the hole diameter before etching was 115 μm as described above. The hole diameter changed rapidly just after the start of etching but the rate of the change of the hole diameter was reduced with the passage of time. This was because the beam emergence side after laser machining was shaped like a sharp angle in section as shown in FIG. 1, so that this portion was etched at the beginning. Accordingly, it is desirable that etching is performed up to a depth sufficient to reduce the etching rate for the double purposes of forming connection between the wall surface of the hole and the surface of the glass substrate on the beam emergence side as a smoothly curved surface and removing the layer denatured by machining.

Further, to make the etching rate as low as possible is advantageous to accurate control of the hole diameter. Accordingly, it is desirable that the hole diameter to be obtained by laser machining is decided on the basis of both etching time and etching depth determined by referring to the characteristic shown in FIG. 3.

Further, because the through-hole formed by laser machining is tapered as shown in FIG. 1, the optical fiber inserted into the through-hole is supported by the smallest-diameter portion of the through-hole. Accordingly, a target value of the beam emergence side hole diameter formed by laser machining as the first step needs to be decided so that the hole diameter of the smallest-diameter portion has a desired value.

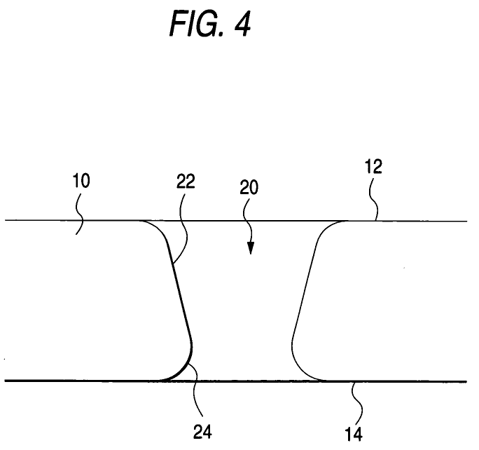

In this embodiment, the glass substrate 10 having the holes formed thus was etched for 10 minutes while the liquid temperature of the etching liquid was kept at 40° C. As a result, a sectional shape as shown in FIG. 4 was obtained. The large number of chips 30 in the boundary between the beam emergence side of the hole and the rear surface 14 of the glass substrate were eliminated by etching, so that the fine hole 20 was formed to have a curved surface 24. A state in which the layer denatured by laser machining could be removed from the hole wall surface 22 was also observed. The hole diameter of the smallest-diameter portion after etching was 125 μm. The standard deviation in hole diameter of the sixteen holes was improved from 2.5 μm before etching to 1 μm after etching.

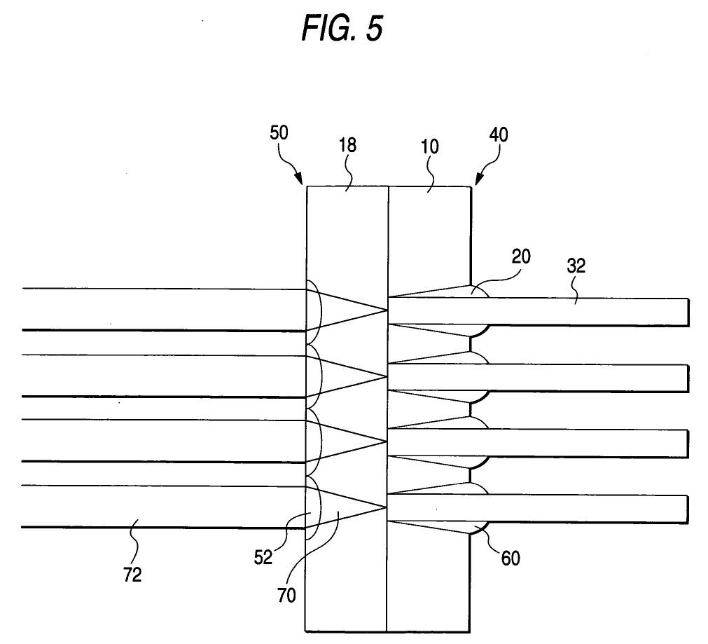

FIG. 5 shows an example in which a glass substrate 10 having an array of fine holes 20 formed therein is mounted as a member for retaining optical fibers 32. A hole array 40 according to the invention is used for arranging sixteen single mode optical fibers 32 as an array of 4×4 optical fibers. Microlenses 52 are formed as a microlens array 50 in a planar transparent substrate 18 so that the position of each microlens 52 coincides with the position of a corresponding fine hole 20 in the hole array 40. The hole pitch of the hole array 40 is made coincident with the lens pitch of the microlens array 50 in advance. Hence, the hole array 40 can be stuck to the microlens array 50 easily while the fine holes 20 are aligned with the microlenses 52 respectively.

The sixteen optical fibers 32 are inserted into the fine holes 20 respectively in the hole array 40 and fixed by an ultraviolet-curable resin 60 or the like. When the microlens array 50 is designed appropriately, a collimator array can be formed so that divergent pencils of rays 70 emitted from the optical fibers 32 are converted into parallel pencils of rays 72 respectively by the collimator array. Light rays propagated through the optical fibers can be coupled to various optically functional devices easily by the collimator array.

By use of the aforementioned configuration, the process for assembling an optical system can be simplified greatly compared with the case where optical fibers are aligned and coupled with lenses individually to form a plurality of collimators.

Although this embodiment has been described on the case where the glass substrate is etched with a mixture solution of hydrofluoric acid and ammonium fluoride, the invention may be also applied to the case where the glass substrate is etched with only hydrofluoric acid. Further, a solution such as KOH or NaOH having a function of etching the glass substrate may be used as the etching liquid.

Although this embodiment has been described on the case where etching is applied to fine holes formed by laser machining, the method according to the invention may be also effectively applied to fine holes formed by another means such as electron beam machining, drilling or sandblasting.

A through-hole formed in a glass substrate by machining or laser machining is further etched in liquid phase so that the hole diameter of the through-hole can be controlled with high accuracy. In the case of a plurality of through-holes, variation in hole diameter of the through-holes can be reduced. In addition, a layer denatured by machining can be removed from the inner wall surface of each hole and the boundary portion between the hole wall surface and each surface of the glass substrate.

1. canceled

2. canceled

3. canceled

4. A method of producing a glass substrate having at least one fine hole, comprising the steps of:
forming the at least one fine hole in the glass substrate by at least one of mechanical machining and laser machining; and
applying liquid-phase chemical etching to surfaces of the glass substrate and the file hole.

5. The method according to claim 4, wherein an etching liquid used for the liquid-phase chemical etching is one of an aqueous solution of hydrofluoric acid and an aqueous mixture solution of hydrofluoric acid and ammonium fluoride.

6. canceled
